(19) United States
(12) Patent Application Publication
(10) Pub. No.: US 2005/0117329 A1
(43) Pub. Date: Jun. 2, 2005

(54) Fixing apparatus for preventing the laser beam of an indicating light pen from being out of focus

(76) Inventor: Wei-Jong Lin, Taipei (TW)

Correspondence Address: TROXELL LAW OFFICE PLLC;SUITE 1404, 5205 LEESBURG PICKE, FALLS CHURCH, VA, 22041, US

(21) Appl. No.: 10/724,081

(22) Filed: Dec. 1, 2003

(51) Int. Cl. B43K 29/10

(52) U.S. Cl. 362/118

(57) ABSTRACT

The invention relates to a fixing apparatus for preventing the laser beam of an indicating light pen from being out of focus with a lower shaft, an upper shaft, a light-emitting module, a cap and a fixing element. A laser head is disposed on the light-emitting module and is ink connection with a focusing lens. The fixing element is positioned within the cap. Meanwhile, the laser head with the focusing lens is located within the cap for preventing the laser head from undesired offset. Therefore, it s not necessary to adjust the focus of the laser head and the cap by use of a rapid engagement, thereby achieving a convenient use.

### BACKGROUND OF THE INVENTION

1. Field of the Invention

The invention relates to a fixing apparatus for preventing the laser beam of an indicating light pen from being out of focus, and more particularly, to a fixing element that is disposed within the laser beam of an indicating light pen. By use of a plurality of recessed parts on the fixing element, the focus of the laser head can be protected from undesired offset, thereby creating a configuration for simple assembly, rapid focusing and convenient use.

2. Description of the Related Art

The commercially available indicating laser light pens are indispensable for teachers. It s troublesome when one has to carry the laser beam of an indicating light pen in addition to a few writing pens. In order to eliminate this trouble, a prior art, like TW 291774, discloses a configuration integrated by a pen and the laser beam of an indicating light pen. This configuration includes a pen assembly and an integrated circuit board. A push button on the integrated circuit board is employed for controlling the lighting fixture on the circuit board. The light beam created by the lighting fixture passes through a light-concentrating ring and a through hole of the screw cap for achieving the indicating effect. However, this prior art still has following drawbacks.

As no components are provided for fixing the lighting fixture (that is lighting head) on the integrated circuit board, the lighting head after performance of calibrating and focusing process is often placed into the screw cap. Thereafter, an external cover is mounted on the screw cap. Nevertheless, this action will easily compress and deform the screw cap due to difficult control over the exerting force, thereby causing the laser beams out of focus. In order to attach a fixing element to the screw cap, this fixing element has to be treated on a lathe, tested, etc. for adjusting the laser beam in focus. This structure has a complicated fabricating and assembling procedure, thereby increasing the manufacturing cost.

### SUMMARY OF THE INVENTION

In light of the demerits of the prior art, the invention provides a fixing apparatus for preventing the laser beam of an indicating light pen from being out of focus that aims to ameliorate at least some of the disadvantages of the prior art or to provide a useful alternative.

A primary objective of the invention is to provide a fixing apparatus for preventing the laser beam of an indicating light pen from being out of focus with a lower shaft, an upper shaft, a light-emitting module, a cap and a fixing element. A laser head is disposed on the light-emitting module and is in connection with a focusing lens. The fixing element is positioned within the cap so as to permit a direct and rapid engagement of the laser head with the focusing lens into the cap 4, thereby fixing the laser head in place. In this way, the problem of the conventional cap and light-emitting module with the laser beam out of focus during the assembly can be avoided. Meanwhile, the laser head with focusing lens is located within the cap for preventing the laser head from undesired offset. Therefore, it s not necessary to adjust the focus of the laser head and the cap by use of a rapid engagement, thereby achieving a convenient use.

### BRIEF DESCRIPTION OF THE DRAWINGS

The accomplishment of this and other objects of the invention will become apparent from the following description and its accompanying drawings of which:

FIG. 1 is a perspective assembly view of a preferred embodiment of the invention;

FIG. 2 is an exploded view of FIG. 1;

FIG. 3 is an enlarged view of the cap and the fixing element of the invention; and

FIG. 4 is a longitudinal section of the invention.

### DETAILED DESCRIPTION OF THE PREFERRED EMBODIMENT

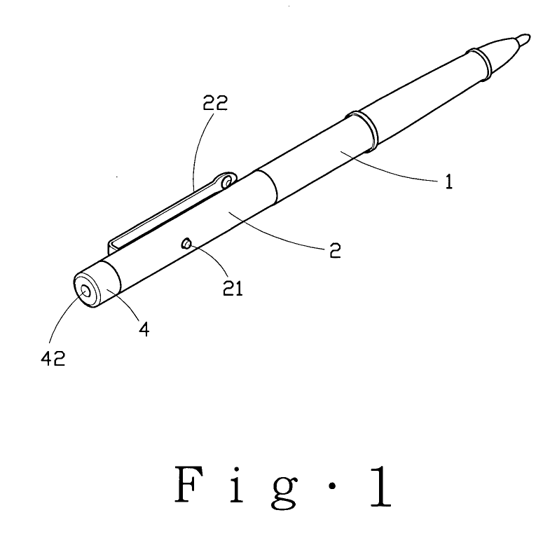

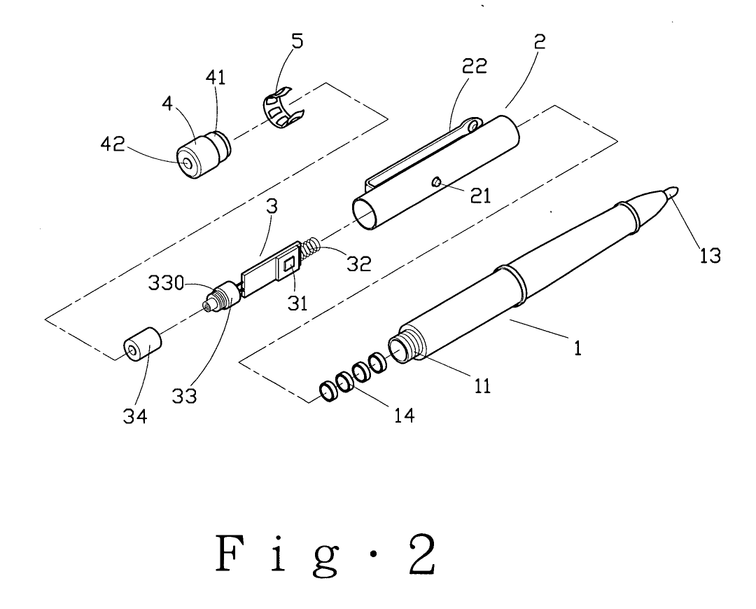

FIG. 1 is a perspective assembly view of a preferred embodiment of the invention, and FIG. 2 is an exploded view of FIG. 1. It s apparent from these two drawings that the invention includes a lower shaft 1, an upper shaft 2, a light-emitting module 3, a cap 4 and a fixing element 5. The lower shaft 1 made of electroconductive material is a hollow tube with a taper sleeve at one end thereof and with an external thread 11 at the other end thereof. An adjusting assembly is fitted within the pen tube for extending or retracting a refill 13 within the lower shaft 1 to a certain extent. The upper shaft 2 is also a hollow tube having an internal thread 23 corresponding to the external thread 11 of the lower shaft 1, a clip 22 mounted on the upper shaft 2 and a push button 21 disposed at a corresponding place to a switch 31 of the light-emitting module 3. The light-emitting module 3 includes electronic components of lighting fixture at one side thereof and the switch 31 at the other side thereof. Meanwhile, the light-emitting module 3 includes a compression spring 32 extending at one end thereof for pressing against batteries 14 and acting as an electroconductive element. Further, it includes a laser head 33 sitting at the other end thereof and having an external thread 330 for receiving a focusing lens 34.

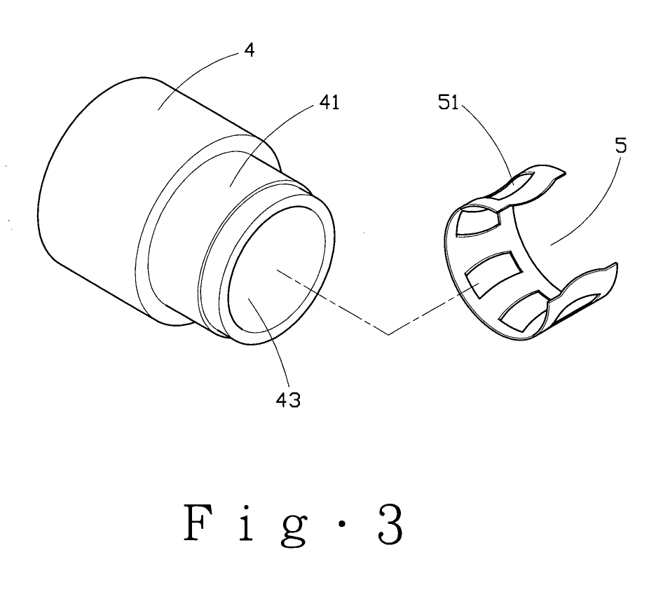

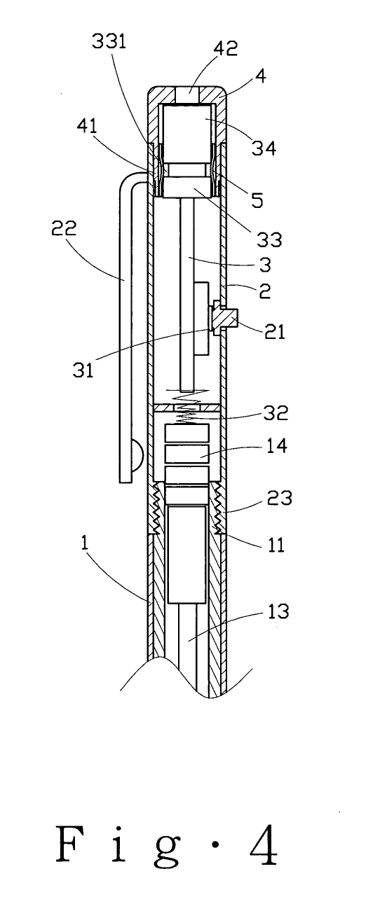

FIG. 3 illustrates an enlarged view of the cap and the fixing element of the invention. FIG. 4 shows a longitudinal section of the invention. As shown in FIGS. 3 and 4, the cap 4 includes a lens 42 at the center thereof for preventing dust or foreign particles from entering into the cap 4. A connecting sleeve 41 with smaller diameter than that of the cap 4 is extended from the bottom of the cap 4 and inserted into the top of the upper shaft 2. The fixing element 5 made of a strip of metal is bent in a ring shape and provided with a plurality of uniformly spaced and recessed parts 51 that are internally arched on the fixing element 5.

In assembly, when the focusing lens 34 is screwed on the laser head 33, an annular groove 331 is created at the joint between both elements. The light-emitting module 3 is inserted into the upper shaft 2 by use of its distal end with the compression spring 32 until the switch 31 of the light-emitting module 3 is aligned with the push button 21 of the upper shaft 2. Thereafter, the batteries 14 are placed into the through hole of the lower shaft 1. Further, the upper shaft 2 is fixed on the lower shaft 1 by means that the external thread 11 of the lower shaft 1 is screwed into the internal thread 23 of the upper shaft 2. In this way, the compression spring 32 of the light-emitting module 3 is pressed against the batteries 14 within the lower shaft 1, thereby creating an electrical loop. In addition, the fixing element 5 is placed in the through hole of the cap 4, and the connecting sleeve 41 is inserted into one end of the upper shaft 2 in such a way as to permit engagement of the recessed parts 51 into the annular groove 331 between the focusing lens 34 and the laser head 33. Accordingly, the light-emitting module 3 is stably fixed in place. By use of the tight contact of the fixing element 5 against the cap 4, the electric current flowing from the positive terminal of the batteries 14 into the laser head 33 forms a closed loop.

In use, the refill 13 within the lower shaft 1 is extendable and retractable by turning the lower shaft 1 with respect to the upper shaft 2. Moreover, the light-emitting module 3 can be stably fixed in place by use of the arrangement of the fixing element 5 within the cap 4. In this way, the invention can not only have the writing function, but also remove the problem of the prior art that the laser beam is easily out of focus. By use of a rapid engaging design, the invention is not required to adjust the focus of the laser head 33 and the cap 4 so as to permit a convenient use.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A fixing apparatus for preventing the laser beam of an indicating light pen from being out of focus, the indicating laser light pen comprising:
a) a lower shaft made of electroconductive material being a hollow tube with a taper sleeve at one end thereof and with an external thread at the other end thereof, an adjusting assembly being fitted within the lower shaft for extending or retracting a refill to a certain extent;
b) an upper shaft being also a hollow tube having an internal thread corresponding to the external thread of the lower shaft, a clip mounted on the upper shaft and a push button disposed at a corresponding place to a switch of the light-emitting module;
c) a light-emitting module having electronic components of lighting fixture at one side thereof and a switch at the other side thereof, the light-emitting module further having a compression spring extending at one end thereof and a laser head sitting at the other end thereof, a focusing lens being attached to the laser head, an annular groove being formed at the joint of the laser head and the focusing lens;
d) a cap having a lens at the center thereof for preventing dust or foreign particles from entering into the cap, a connecting sleeve being extended from the bottom of the cap und inserted into the top of the upper shaft;
e) a fixing element made of a strip of metal and bent in a ring shape, the fixing element being extended and fixed within the cap in place, the fixing element further having a plurality of uniformly spaced and recessed parts that are internally arched on the fixing element so as to permit engagement of the recessed parts into the annular groove between the focusing lens and the laser head, thereby preventing the laser head from undesired offset, so that an adjustment of the focus of the laser head and the cap is not necessary and a convenient use is achieved by use of the rapid engaging design in the fixing element.
